(19) United States
(12) Patent Application Publication
(10) Pub. No.: US 2006/0196928 A1
(43) Pub. Date: Sep. 7, 2006

(54) System and method to assist patients in complying with medication regimes

(76) Inventor: Edward G. Castagna, Middlesex, NJ (US)

Correspondence Address: HOFFMANN & BARON, LLP, 6900 JERICHO TURNPIKE, SYOSSET, NY, 11791, US

(21) Appl. No.: 11/365,279

(22) Filed: Mar. 1, 2006

Related U.S. Application Data
(60) Provisional application No. 60/657,334, filed on Mar. 1, 2005.

(51) Int. Cl. G06F 17/00

(52) U.S. Cl. 235/375

(57) ABSTRACT

A Medication Recording System of the present invention is an electronic daily medication planner which assists a person to comply with his or her medication administration needs and to communicate with caregivers about their diagnoses, allergies and current medication schedule. The Medication Recording System provides a way to create a daily medication schedule, update and modify one's medication schedule, applicable portions of their medical records and other health information.

### CROSS-REFERENCE TO RELATED APPLICATION

This application claims priority to U.S. Provisional Application No. 60/657,334, filed Mar. 1, 2005, which is incorporated herein.

### FIELD OF THE INVENTION

This invention relates in general to electronic medical record systems and more particularly to an electronic medical record system using a text database to store a person's medication prescription information. The system follows HIPAA rules concerning confidentiality of patient information.

### BACKGROUND OF THE INVENTION

Today more and more responsibility is placed on people to coordinate their own healthcare and to be involved in the healthcare process. A major flaw in current prescription practices is that a person may become incapable of administering their medication as prescribed or to inform various caregivers of their medication regimes. Failures using this system are evidenced by the high incidence of Emergency Room visits due to a patient's failure in taking medicine(s) as directed.

The current best practices in medicine makes it important for doctors to get an informed consent from a person before beginning any treatment plan. The nature of the informed consent is to have the responsible party commit to following through on a prescribed treatment plan. Without this informed consent, the doctor cannot begin the treatment plan except under emergency situations.

Under the existing system a typical doctor's office visit may include the doctor diagnosing that there is something wrong with a person (diagnosis). The doctor envisions what can be done (treatment plan) to either help the person get better or not get worse. The doctor will describe this treatment plan to the person, and will report if any improvements can be hoped for (prognosis), and how long the treatment plan will need to be in effect as improvements are monitored and noted. As part of the treatment plan, the doctor may prescribe some medications to help the person improve their condition.

The doctors have the responsibility of taking the information from the patient (allergies, diagnoses, medications, past history of ailments); diagnosing current condition during an office visit (or suggesting additional tests which would help to successfully diagnose a condition if a variety of conditions may have the same symptoms); suggesting one or more treatment plans to help the patient get better, or not get worse; describe the medicine needed by the patient if medicine is part of the treatment plan; get the patient's consent to take the medicines as prescribed and to notify the doctor of adverse reactions to the medicines; and prescribe the medicine and schedule any follow-up visits to monitor progress.

However, typical doctor's office visit still doesn't answer the additional questions of:

Can I take these at the same time as meals?

Can I take these at the same time as other medications?

Are there any interactions with foods?

Are there any interactions with other medications?

What is the diagnosis this medication is for?

What do the pills look like that you are prescribing?

What do the generic version of these pills look like?

What are the side effects that are OK?

What are the side effects that need to be brought to the attention of the doctor?

What time of day should I take these medications?

For answers to those questions, the patient is expected to read the information which the pharmacist gives the patient when the medicine is dispensed.

Many problems arise out of the existing system that needs to be addressed. For example, the patient does not understand information given by the doctor. People sometimes, when being told about a new (bad) diagnosis will acquire very little of the new information given. It is now the person's responsibility to manage and administer medications. It is only the doctor's responsibility to give the person medication information, it is not the doctor's responsibility to make sure that the person understands the information given. Without having the medications written down, it could have serious consequences if the patient does not follow through on administering prescribed medications with the expected urgency. Further, many emergency room visits are due to the person not administering their medications as prescribed.

Further, the patient may seek a second opinion from a different doctor and that diagnosis or treatment may differ from the first doctor's evaluation. This adds to the confusion of the patient especially if the basic answers as above-discussed are not fully understood by the patient.

A concern with this system is managing the complexity of drug interactions (what drugs can be taken at the same time, what drugs can be taken at different times, which drugs can be taken with certain foods, etc.)

Prior Art relating to Electronic Medical Records and Online Data systems does not address the Patient's need to understand medication administration requirements nor to give them sufficient method to simplify the presentation of information so they are better able to administer medications without assistance. Although there have been attempts to facilitate portions of recordkeeping using Internet Information, there has not been a mechanism available to help those people without Internet Access.

Thus, there is a need to provide a more reliable and accurate system to assist doctors in prescribing medicine, taking into account the patient's current medication administration needs. Further, there is need of a system to provide a patient with a simple visual daily schedule of medicine to provide better understanding of what medication needs to be taken and when it needs to be taken.

Furthermore, there is a need for a system to update one's medication schedule and verify accuracy so that a patient would feel comfortable relying on the schedule and be more apt to comply therewith.

Additionally, there is a need for a system in which patients and doctors can rely to provide updated and accurate schedule of daily medicine to be taken.

### SUMMARY OF THE INVENTION

The Medication Recording System of the present invention helps a person and their caregivers coordinate the adoption and follow-up of medication administration added to the person's daily activities. The System assists a person to comply with his or her medication administration needs and to communicate with caregivers about successes and failures in medication administration.

A Medication Recording System Schedule is a day planner that includes the time of day for administration of medications, expected food intake times, expected medical testing times.

The Medication Recording System is a computer program which supports the processes which will be noted below and creates the Medication Recording System Schedule printed output.

It includes a process for bringing the Mediation Recording System Schedule with you to office visits for the doctor to use as information that could be helpful to evaluate allergies and drug interactions.

It includes a process for bringing the Medication Recording System Schedule with you to office visits so that the Medication Recording System Schedule can be updated after conferring with the doctor and accepting the doctor's advice as to implementing the treatment plan.

It includes a process for bringing the Medication Recording System Schedule with you to the pharmacist to let them know all the current medications you are taking so that they can correctly check for medication and food interactions.

It includes a process for bringing the Medication Recording System Schedule with you to the pharmacist to assure that medication and food interactions are double checked to assure that the person has been informed of the possible side effects to look for if you are taking a specific medication.

It includes a process that can be used with nurses to log that they have evaluated the patient's ability to self-administer the medications.

It includes a process that can be used by the patient to log the self-administration of medications.

The present invention provides a method of creating an individualized medication recording system, including the steps of providing an electronic version of a medical records system; accessing a personal account of the medical records system to provide an individual medical records system; setting parameters within the system to enable authorized users to view or edit information stored on the individual medical records; inputting personal medical information where prompted to on the individual medical records system; and compiling the personal medical information to provide a usable and viewable format.

Further, the inputting step may includes personal medical information which includes name of medication, dosage requirements, number of times a day of administering and time of day to administer the medication or combinations thereof. The method may further include the step of printing the daily medication schedule. The method may include the step of following a regimen set for in the daily medication schedule, completing task by taking medication at indicated time of day and dosage as indicated on the schedule and marking the daily medication schedule to indicate completion of task, following regimen until all tasks are completed and the daily medication schedule reflects completion of regimen.

The present invention is further directed to the method including the step of modifying the daily schedule by adding or deleting personal medication information and creating updated daily medication schedule. The method may further include the step of checking drug interaction between medications listed on daily medication schedule. The method may further include the step of listing all drug interactions for review by patient. The method may further include the step of electronically saving the individual medical records system information for future access, updating and review thereof. The method may further include the step of accessing the medical records system to authorize other users to view or update the personal medical information. The method may further include the step of accessing the medical records system by authorized user for viewing or updating in accordance with predetermined access levels. The method may further include the step of accessing the medical records system by the individual for the purpose of printing out a pill sorter filling sheet for updated daily medication schedule. The method may further include the step of notifying a primary care provider when the daily medication schedule is updated within the medical records system. The method may further include the step of authorizing a healthcare proxy who will be able to view and update the information within the medical records system when the individual is deemed needing assistance of their predefined healthcare proxy. The method may further include the step of storing protected health information on a Fingerprint Authenticated USB Device portable data file cabinet for read access after a fingerprint of the individual has unlocked the information found in the USB Device.

Furthermore, the method of the present invention may include the step of storing medication dispensing information by an authorized pharmacist and/or the step of printing a report of medications to be renewed refilled in coming month.

The present invention provides for a system for providing a medication recording schedule including a electronic processing system; a medical records system accessible through the electronic processing system to input medical information specific to a user and store the information thereon; a daily medication schedule outline stored on the electronic processing system, the outline divides a day into various categories as a function of time, each category includes a section to display medication to be taken, dosage amounts of the medication, time of day of administering medication and a tab to check off upon completion of the medication intake; a compiling mechanism which links the information stored on the medical records system to the daily medication schedule outline, the compiling mechanism individualizes the schedule by inputting medication names and dosages in to the appropriate category on the outline for a visual display of an individualized daily medication schedule; a printing mechanism to print the individualized daily medication schedule; and a notification mechanism to notify primary cares of modifications to the individualized daily medication schedule. The system may further include a Fingerprint Authenticated USB Device portable data file cabinet for storing protected health information thereon.

Furthermore, the present invention provides for a medication recording system schedule including a customized hard copy daily schedule of an individuals medication routine for a day, the schedule includes breakdown of a day as a function of time; medication information including at least one medication name, a dosage requirement for the medication, time of day of administering medication; and a recording system to denote medication was administered, the medication information being assigned a specific time of the day for administration. The schedule may further include an electronic version of said schedule to be stored on a Fingerprint Authenticated USB Device portable data file cabinet as a read-only file.

### BRIEF DESCRIPTION OF THE DRAWINGS

FIG. 1 is a block diagram of the overview of a system of the present invention.

FIG. 2 is an example of a patient medication recording system schedule of the present invention.

FIG. 3 is a block diagram of the system of the present invention to create/updating of medication schedule print from data/records store/entered for patient's prescription of the present invention.

FIG. 4 is a block diagram of the present invention including the steps to manually creating an individualized Medication Schedule.

FIG. 5 is a block diagram of the system of the present invention including the steps for a doctor to modify an existing individualized Medication schedule.

### DETAILED DESCRIPTION OF THE PREFERRED EMBODIMENT

The present invention seeks to provide a process and system for a patient to keep track of their current medication schedule and to share the schedule with various providers. The present invention provides for a Medication Recording System (MRS) for a patient to improve their medication self-administration and to empower them to take a more active part in the medication administration process. It will integrate with an electronic medical record and be a source of record sharing medications between patients, providers, and healthcare workers.

Providers herein are defined as primary care physicians, specialists, non-primary care physicians, dentists, nurses, pharmacists, patient advocates and other medical personnel who come in contact with the patient and are responsible for generating, prescribing, recording medication dispensing, recording medication administration and recording adverse reactions.

Visits with any of these caregivers can include a review of the current medication schedule (with feedback to primary care doctor if indicated) and may include updating the record with prescription and medication administration information. Each recorded encounter may adjust the patient's schedule.

In the preferred embodiment, the Medication Recording System is capable of receiving and transmitting medication information from and to a large number of offices existing in multiple buildings at multiple sites. Data may be accessed from offices on a Local Area Network or over the Internet if it needs to be shared between greater geographic distances. When consultation is needed with Global Physician Team Members, this would be facilitated through the Internet. The schedule would reflect the current medications prescribed by all providers.

The system, of the present invention, will assist the doctor/person relationship by allowing the doctor to see a person's schedule and to tell the patient at what time this new medication should be taken. The Pharmacist who will be filling the order for medication then verifies a second time the patient's revised schedule.

This system, when processed in a short doctor's office visit gives the patient a permanent record of the new Medication Recording System Schedule in a printed form with supporting documentation including:

Doctor's Diagnosis of the Illness.

Immediate medication needs.

Information needed to understand the medication administration needs and how they interact with other known medications.

The drug information sheet should be reviewed in the doctor's office rather than later at the pharmacy. The patient has a better chance of complying with the medication scheduling if they understand why they are taking the medication and understand and accept the risks and possible side effects.

If a patient has committed to taking the medication regularly, and adjusted their schedule accordingly, there is a better chance of patient compliance with medication regimes.

If a person is preoccupied during a visit, but leaves with a new medication schedule, they will be more able to remember which medication changes need to be scheduled into their daily activities.

If, by having a patient schedule, the patient is better able to track their self-administration there will be less of a chance that they will need an Emergency Room visits to rectify their medication administration failures.

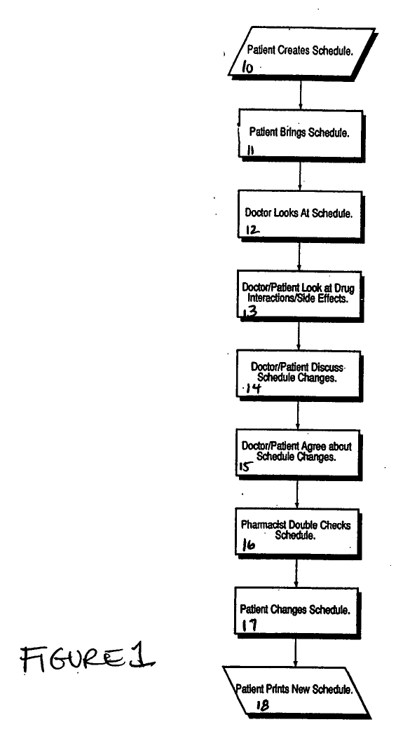

FIG. 1 shows a block diagram overview of the system of the present invention. Initially, the patient must create a medication schedule 10. While it is contemplated that a person may create their personalized medication schedule via a home computer using software package, it is preferable to use an Internet application which provides viewing access to authorized providers. Herein, we will describe the use of the internet application but the software (home PC) version is a similar process as described below. The patient signs up at http://www.medrecsystems.com (herein “Internet site”) using a login ID and password. The Internet site provides a database to maintain all current health information and medication schedule information. After subscribing to the Internet site, the patient may choose medications using the Change Medications Page. The patient may click and choose to add or delete medication from the list provided. The patient inputs the medication at the appropriate times to be administered in accordance with the doctor's prescribed administration plan. The patient repeats this process until all the medication is entered at all the appropriate times. The schedule is saved as each medication is added. The patient may then print out a copy of the medication schedule.

Further, the patient may use a Fingerprint Authenticated USB Device interface in connection with the above-described service. The Fingerprint Authenticated USB Device is a portable data file cabinet which is unlocked by reading and identifying the patient's fingerprint. The Fingerprint Authenticated USB Device is plugged into one's computer prior to logging onto the Internet site. The patient medication schedule is created as above described, i.e., choosing a medication, plugging it into the appropriate time slot per the prescription plan, and repeating until completed. A new updated copy of the medication schedule will be stored on the Fingerprint Authenticated USB Device in a protected area in a file name., i.e., MedicationSchedule.pdf. Therefore, computers having similar software, i.e., Adobe Acrobat Reader, will be able to open and print the Medication Schedule.

Further contemplated is the use of additional media formats as they can be protected easily. A copy of the new medication schedule will be stored on the additional media format in a protected area in a file name, i.e., MedicationSchedule.pdf. Computers having the associated software, i.e., Adobe Acrobat Reader should be able to open and print the schedule.

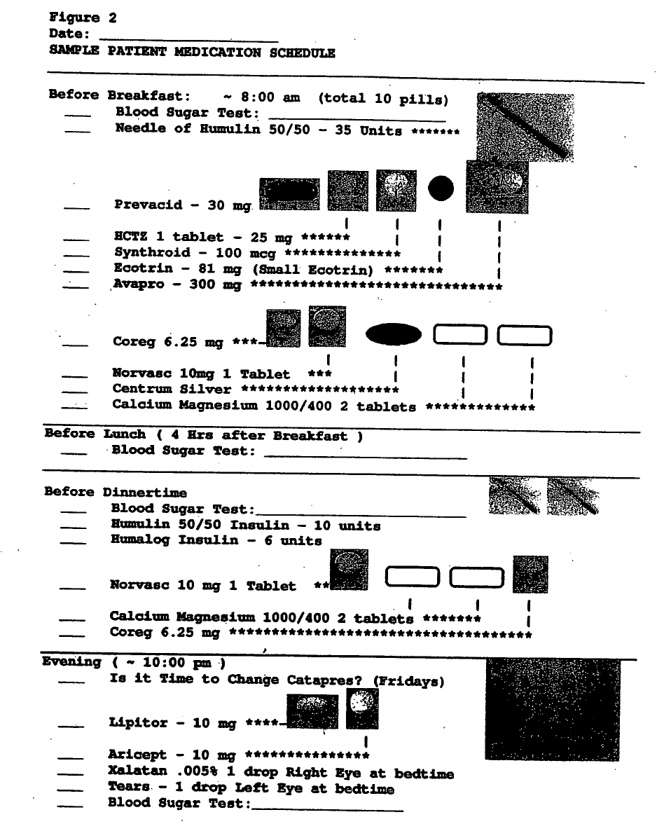

Multiple copies of the schedule can be printed for daily use. The patient checks off on the printed schedule on the line provided for the medication administration. FIG. 2 shows an example of a patient's medication schedule.

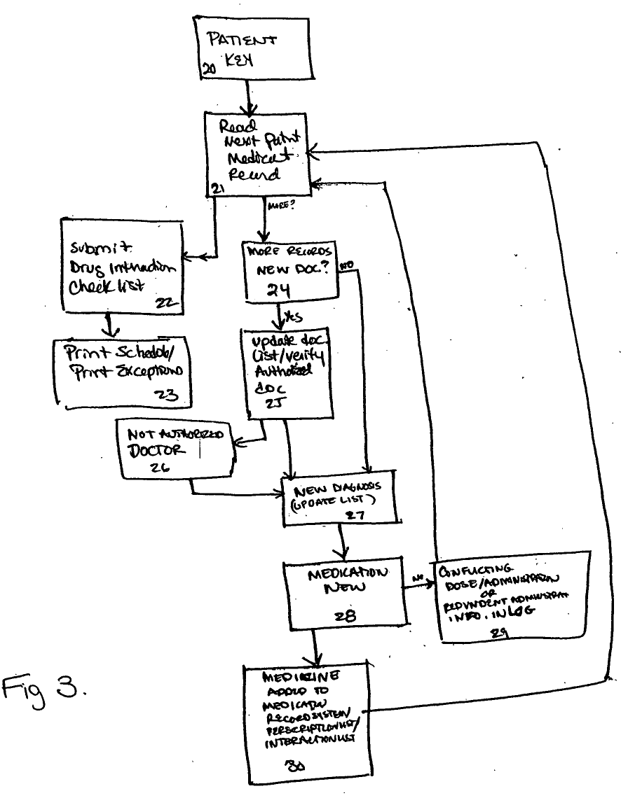

FIG. 3 shows a block diagram of printing medication schedule from patient records. Initially, the patient is identified (20) or logged in using appropriate passwords. The patient medication records are obtained and verified (21). If there are no additional patient records to add or change within the current treatment plan, then the system proceeds to check interaction of drugs (22) (using information provided by Internet site, doctors, patients, etc.). The medication schedule is printed and a list of exceptions is printed (23). However, if additional health records, prescriptions are retained/inputted, then the system checks if the doctor associated with this new record is new (24). If the doctor is new, the doctor is updated on the list of doctors associated with this patient and the patient is solicited for the doctor's level of authorization to the medication schedule and verifies the authorization (25). If the doctor is not authorized, then the doctor is listed as an unauthorized doctor (26). Next the patient proceeds with diagnosis information. The system checks the diagnosis (27). If the diagnosis is new, then the diagnosis list is updated (27). Next, the system checks if the medication prescribed is new (28). If the medication prescribed is not new (29), i.e., existing medication, the system checks if there is conflicting dosing or administration, the system will flag medication conflicts, or redundant administration info in log. The system then repeats to add the next patient medication record (21) until all the information is added. Then it will check the drug interaction 22 and print a schedule and exceptions (23).

However, if the medicine is new to the patient medical schedule, then the system obtains the medicine key information, obtains a picture of the medicine, placed the medicine in the appropriate time block for administering it, updates the medication record system schedule, adds notes from the doctors/pharmacist, updates medication prescription list and adds medicine to drug interaction check list (30). The system repeats the process reading the next patient medication schedule record (21) until all the information has been added/updated. Then the system checks the drug interaction list (22), prints the schedule and exception (23) as above discussed.

Once the Medication Recording System Schedule (schedule) has been created then the patient can use the schedule for keeping track of daily medication accuracy as above-described. Patients can refer to the medication schedule to help the patient in remembering administration times. Once the medication has been put on a schedule, there are then many other possible ways of reminding you that you need to take your medicine at some point in the day. You could remember when the next time you need to take medication is, and then refer to your schedule at that time. You could set up a reminder system which would notify you that the next medication time has arrived and then let you know (with pictures if possible) what medications need to be taken. The system could assist in providing a variety of reminder systems such as an alphanumeric pagers, e-mail, cell phone instant messages, or computerized instant messages. You could setup a prescription robot to talk with you about administering your medications based on the medication schedule. You could print out a copy of a pill-sorter filling sheet which gives you information about how to fill up your weekly pill sorter so that the right medications are in the right compartments.

Additionally, once the schedule is created it is then a useful tool for the doctors, patient, specialists, pharmacists to update, verify accuracy and drug interaction, etc. FIG. 1 shows that once the schedule is created then the patient should bring it with them to the doctors for review of the schedule (12), drug interaction list (13), any changes/updates (14). The doctor and patient agree on the updates and changes (15). The updates and changes are accomplished in a variety of ways one being similar as described above in creating the schedule. The details for updating/changing the schedule will be further described in detail below. Bringing a paper copy, Fingerprint Authenticated USB device/other media format to access the schedule provide many advantages over the current practice. This informs the doctor what medications the patient is taking. If the doctor asks you if you are taking any new medications, you are prepared by showing them your current medication schedule. Sometimes medication names are very similar and if you try to remember which medication has been prescribed by one of your doctors, it may be that the medication name you are giving the doctor is not the same name as the medication you are taking. Further, it lets the doctor know what time of day you are taking your medications. Furthermore, the medication schedule allows the patient to enter the times that they took the medications as well as the times of day of doing regular events. If you wake up regularly for work at 6:30, you would include that on the schedule. If you regularly eat lunch at 12:00, you would include that on the schedule. If you regularly eat dinner at 6:00 pm, you would include that. If you workout between 6:30 and 7:30 am you would include that. If you have been prescribed to take the medications at breakfast, at dinner, at bedtime, two hours after lunch . . . whatever, that naming of time by familiar naming can be included in the schedule. The paper copy does not require the doctor to have a computer to read your smartcard or Fingerprint Authenticated USB Device, MedicationSchedule.pdf.

However, if the doctor's computer can read your Fingerprint Authenticated USB Device, you can unlock it with your fingerprint for the doctor and have them print out your MedicationSchedule.pdf. Additionally, if additional media formats are supported, the doctor's computer can read the other media format after you unlock it by typing in your secret password for the doctor and have them print out your MedicationSchedule.pdf. There are many advantages for the doctors to have access to the schedule and the doctors to participate in this system because of the accuracy and ability to continually monitor a patients' schedule.

Next, if the doctor suggests that you change your medications during an office visit, the system provides the doctor with a picture of your current medication and schedule to allow the doctor to make a more informed decision when choosing a new medication to add or to substitute with a current medication. After the doctor reviews the schedule, the doctor will prescribe the new medication, lookup the medication information, print the drug information sheet and review it with the patient in view of the current schedule. The patient and doctor verify that there are no conflicts with the new medication. There are a couple of steps which need to be done before you commit to taking the prescribed medication. First, the doctor should tell you what it is that he/she believes is wrong with you. The doctor should discuss with you the benefits of using the medication (will you get all better? Will this help you to bear the pain? Will this help relieve some symptoms?). The doctor should tell you how long you will need to take the medication. The doctor should tell you what the typical side effects of the medication might be. The doctor should tell you what are the side effects which might be experienced which should be urgently discussed with the doctor. The patient would then let the doctor know if they think they will be able to take the medication without any help or would need help to either take the medication or to remember to take the medication. Some problems arise with taking medication when medications are not taken as prescribed.

Doctors typically are familiar with interactions between medications. There are many different medications in the market nowadays. It is a useful step to “run an interactions check” against all the medications you are taking. This is a process in which a list is created of all the medications you are taking and then you press a button and a report is displayed or printed which discusses some mild, medium or severe medication interactions. The patient and doctor should consider this information when taking the medication. The medication list would include prescriptions, as well as herbal and alternative medicine and vitamins.

If there are contradictions/conflicts when adding a new medication to the patient's current schedule (or if the patient is not willing to take this new medication) the doctor may need to further discuss options with the patient. For example, the doctor can substitute a preexisting medication already on the schedule to overcome drug interaction with new medication or suggest a different drug with less interactions then the proposed new medication. Further, the patient may wish to obtain a second opinion and refrain from adding a new medication at this time. The doctor must be aware of this and may make notes in the Medication Recording System regarding their discussions for the patient to refer to in the future. Further, if the patient is not agreeing with the doctor to add the new medication risking potential side effects, this refusal reason should be added to the MRS. If the medication is not taken during the time they seek a second opinion, then the patient must be made aware of any potential risks or concerns and notes maybe added to the Medication Recording System.

However, if the patient and doctor agree on the addition of the new medication or a change to the current Medication Schedule, then the doctor would markup the schedule with a pen to include the new medication, and notes (hopefully, this is legible, if it is not, you can ask the people working at the front desk to verify the spelling of the medication). In the past, when the doctor said “take two of these a day”, some typical follow up questions might be two times a day, does that include in the middle of the night when I am sleeping? Is it ok to take it the same time that I'm taking my other medications? Is it ok to take it with meals? Is it ok to take it before meals? Is it ok to take it after meals? Are there any foods which I shouldn't be eating at the same time I'm taking this medication?

If the doctor has marked up your existing schedule, these considerations are handled because the doctor has prescribed a specific time of day you are to take the medication. Typically, you're not able to get an answer to these questions until after you have reviewed the medication documentation to find out for instance that the medication's effects are not as strong if you eat grapefruit. If the doctor prescribes to the system of the present invention and you authorize the doctor to access to your Medication Recording System Schedule then the doctor can directly update your schedule by clicking on the medication to be added/deleted/changed, place it in the correct time schedule. If using the Fingerprint Authenticated USB Device the doctor can update the USB Device after you have unlocked it with your fingerprint. Update of other media formats is done in the same manner. The doctor may add additional notes if necessary and print an updated schedule for the patient. The doctor's direct access to their patient's Medication Recording System Schedule allows for immediate updates and notes for the patient. Also, it provides a visual inspection of the new schedule for the patient to a better understand of the new schedule and any questions may be addressed at that time instead of after the fact once the medication has been purchased and dispensed with the drug information sheet.

Furthermore, if you go to a specialist or other doctors, and you have the schedule with you then the doctor can make a more informed and therefore better judgment because they know exactly what the specialist/other doctors prescribed. There is no waiting time for your doctor and the specialist to clear their schedules to talk about the medication. Your doctor will know right away if there is a potential interaction between the rash medication and the heart medication the specialist prescribed. That leaves a lot less up to chance.

The patient schedule may be updated by a specialist or non-primary doctor if the patient authorizes the doctor access to the Medication Recording System Schedule, and the doctor is a participant in the system of the present invention. The process is similar to a primary doctor. The non-primary doctor may access the information via computer (internet service) or paper copies if the patient brings them in. The non-primary doctor will review the schedule including i.e. allergies, diagnoses, and medications. The non-primary doctor will note a diagnosis and review with the patient. If medication needs to be added/changed from schedule then the non-primary doctor will review the medication with the patient, side effects, verify non-interaction with other medications in the Medication Recording System. If the patient accepts the doctor's recommendation and allows this medication to be added, changed, etc. then the schedule is updated by the non-primary doctor. The non-primary doctor adds the medication to the schedule, places the medication in the appropriate time of day, and any notes about the patient's ability to take medications. Further, the primary doctor is notified of the changes to the schedule via the system of the present invention. However, if the patient does not authorize the non-primary doctor access to their Medication Recording System then the doctor will write notes onto the printed copy of the schedule and the patient will make the changes to the Medication Recording System themselves and any notes associated therewith. The system will notify the primary doctor or other providers as authorized by the patient of any changes to the schedule.

One example of the primary doctor being notified of the patient's schedule is described below. After the schedule is updated, then the non-primary doctor sends a copy of the updated schedule to the primary doctor. The printed paper copy will have the primary doctor's name and facsimile number on it and the non-primary doctor may send it via facsimile. Otherwise, if the non-primary doctor has access to the patient's Medication Recording System, then the non-primary doctor logs in the system using the access number given to the doctor. The doctor will update the patient's schedule and the system will automatically notify the primary doctor of any changes to the patient's schedule. The primary doctor may set up the mechanism of notification, such as automatic e-mail, facsimile, postal service, or other such services. Additionally, if the patient enters the changes the primary doctor will similarly be notified of any changes to the schedule. While this notification system is highly recommended, the patient may limit the notification process.

One advantage of the system of the present invention is the drug interaction check that the system performs. Once the new medication is added to the schedule, including the dosage, times per day, length of time expected to take the medication, then the interaction check is performed. The system will display any interactions. If the interactions are determined to manageable by the doctor, patient or combination (based on initial prescribing), then system sets up a monitor to monitor the symptoms. The system will assist in putting monitoring systems in place if patient believes they need help with reminders to administer medications. If the patient is unable to be monitored and monitoring is required, or if the interactions are not manageable, the doctor is notified using the notification process described above. Further, the medication will not be added to the schedule until the interactions/conflicts are resolved.

Referring to FIG. 1, once the patient and doctor, specialist, provider, etc. has agreed to make the changes to the schedule and prescribed medication (15), then the pharmacist double checks the schedule (16). At this point the doctor may have already changed the schedule if they had authorization to do so by the patient and access to the system, or the changes may have only been added to the paper copy and the patient will enter changes. Either way, the pharmacist has a prescription to fill. The pharmacist, if he is authorized and has access to the system, can print out a copy of the patient's medication schedule if requested by the patient.

The present invention provides the pharmacist with a role of double checking the medication prescribed, possible interactions based on current medication schedule and verifying medication schedule with the introduction of this new medication.

Generally, the pharmacist reviews the changes since last dispensing of medicine (prescription) and the patient schedule. The pharmacist checks the schedule changes, including the new prescription. The pharmacist verifies all the relevant dispensing information surrounding the new prescription, i.e., new medication name, dosage, times/day, times/week, cycle, time of day. The pharmacist checks the drug interaction between the new medication and the currently taken medication as well as the schedule and appropriate placement of the new medication in the schedule. If there are interactions, then the pharmacist reviews the interaction with the patient. Based on the type of interaction, the pharmacist determines if it is manageable based on the medication schedule and patient's ability to handle the monitoring of this interaction. However, if the patient requires help in monitoring the interaction, or if the interactions are to the level that the pharmacist needs to notify the doctor then the pharmacist notifies the doctor immediately and the doctor must approve the prescription in view of the interaction concern or change the prescription accordingly. Once the appropriate approval is sought, and no interactions exist or the interactions are manageable, then the pharmacist adds the medication to the schedule (if they have authority to do so and it is not already on the schedule). The medication is dispensed. The Medication Recording System is updated with dispensing information. The Medication Recording System includes the dispensing information previously discussed. This allows the Medication Recording System to be used as a reminding tool for renewal/refill of medication. The reminding tool can be e-mail, fax, computer notification to patient, doctor or pharmacist depending on who has access and authorization based on the Medication Recording System defaults initially set up by the patient. The renewal/refill process contacts the pharmacist for a refill. If a renewal is required, the doctor is notified. If there is no response from the doctor with a set amount of time, the pharmacist sends a reminder to contact the doctor directly. Once the renewal/refill is authorized, the MRS processes the order. The medication is dispensed and picked up by the patient. The MRS is updated regarding dispensing information, number of refills, expiration date, and date of new refill.

A further aspect of the MRS is the process by which the patient (or caregiver) administers and records administration (i.e., pill sorter, paper schedule, standard transaction interface, etc.). There are various ways to record the administration using the MRS. The patient records the administration of the medication using the paper system, online system or a handheld administration recorder. If the doctor wants to be informed of the administration, the electronic versions (i.e., online, hand held device) will automatically notify the doctor. The paper copy will remind patient to contact the doctor. If the doctor does not request to be informed, then no reminder is sent but the electronic version of the MRS is updated in case the doctor wishes to look it up at a later date, provided they were authorized to access MRS by patient. Further, all information is updated so the doctor can view at the next office visit.

The medication recording system of the present invention is adopted to use HL7, the standardized messaging protocol used in the health care industry. One example of HL7 transaction used to update the medication recording system and schedule from an external source with doctor, pharmacist, medication, dosing and administration information, diagnosis, patient information, allergies, next of kin, etc.:
MSH (Required for any HL7 Transaction)
EVN (P01=add new account, P05=update existing account)
PID (Patient Information which identifies the patient, required to uniquely identify a patient, probably from their security certificate)
NK1 (Next of Kin Information for Patient)
PV1 (Patient visit in which the medication was prescribed, required if the doctor has prescribed this medication during an office visit)
DG1 (Patient diagnosis, required if the doctor is creating a new diagnosis for the patient, or addressing a specific diagnosis by the prescribing of medicine)
AL1 (Allergy information, required if the doctor has allergy information concerning this patient)
ORC (Common order, required or any HL7 order)
RXO (Pharmacy/treatment order segment, required for any pharmacy order)
RXR (Administration route, PO is by mouth)
RXD (Pharmacy/treatment dispense segment, when medicine is dispensed from pharmacy)
RXA (Pharmacy/treatment administration segment, when medicine is administered to patient, including self administration)

Unverified Transaction:

MSH|\hat{ }˜\&|UREV||PATB||||BAR\hat{ }P01|MSG00181|P|2.3<CR>
PID|||125976||JOHNSON\hat{ }SAM \hat{ }||||||||||125976011<CR>
NK1|JONES\hat{ }BARBARA\hat{ }K|WIFE||||||NK\hat{ }NEXTOFKIN<cr>
PV1|1|I|2000\hat{ }2012\hat{ }01|||004777\hat{ }LEBAUER\hat{ }SIDNEY\hat{ }J.|||SUR|||ADM|A0|<cr>
DG1|001|I9|1550|MAL NEO LIVER, PRIMARY|198805011030051|<CR>
AL1|DA|Hives|Allegeric to Sulfa|SV|19880501103005|<CR>
DRG|203|198805011030|Y||D|5<CR>
ORC|NW|1000\hat{ }OE||||E|\hat{ }Q6H\hat{ }D10\hat{ }\hat{ }\hat{ }R||||||<CR>
RXO|RX1001\hat{ }Polycillin 500 mg TAB\hat{ }L|500||MG|||||G||40|<CR>
RXR|PO|<CR>

Further, the system allows one to print medication schedule from records. An example of the process to print is as follows:

Figure out Patient Key.
-read rec
read Next Patient Medication Record.

(yes) > procrec
(no)> nomorec

?end
- procrec
New Doctor?

(Yes)

(No) Generate Doctor Not Authorized Exception.

? end

?end
New Diagnosis?

(Yes) Get Medicine Key Information.

Get Picture of Medicine.
Figure which Time Block to Administer.
Note Review Doctor, Pharmacist.
Update Medical Prescription List.
Add Medicine to Drug Interaction Check List.

(No) Existing Medicine.

Conflicting Dosing or Administration?

(Yes0 Medication Conflict Exception.
(No) Note Redundant Administration Info in Logs.

? end

?end
>readrec
-nomorec
Submit Drug Interaction Check List.
Print Schedule.
Print Exceptions.

If the paper schedule has changed but has not been updated by the doctors or pharmacist, then the patient can adjust, change or update the schedule. The process of updating the schedule is similar to the process of creating the schedule as above-described, where the patient adds/deletes the medication from the schedule.

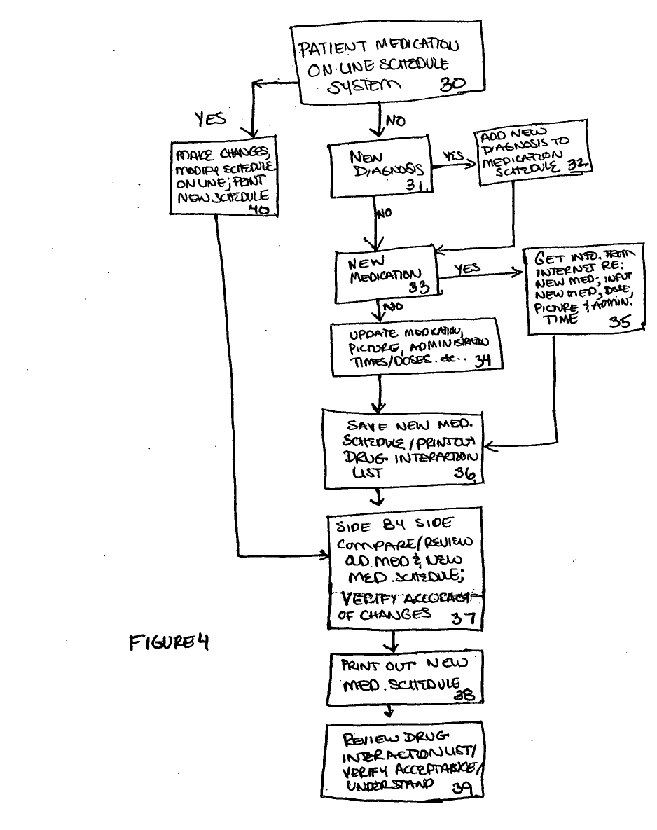

FIG. 4 shows a block diagram of the steps to change the medication schedule. If one is not using the system (30), then one uses their word processor to enter new diagnosis (31) (32). If there is no new diagnosis, then they enter changes to medication (22). If there is no new medication (33) then they enter the changes to the schedule (34) (i.e., times, doses, etc.). If there is new medication, then they get information regarding this medication from the internet (35), i.e., www.pdrhealth.com, drkoop.com. They input the information, medication, name, dose, pictures and administration time (35). Once all the changes/modifications have been entered then a new medication schedule is saved and a drug interaction list is printed out (36). A side-by-side review of the old schedule and new schedule is performed, a verification of the expected changes to the schedule is completed (37). If there are any discrepancies or unexpected results/changes, then the process is started over to modify errors. Otherwise, the new schedule is printed (38). The drug interaction list is reviewed (39) and if the patient has concerns regarding the interaction list, then they discuss it with the doctors (40).

FIG. 4 shows that if the patient is using the patient medication system (on-line) (40), then the changes are done similar to the manual system of FIG. 4. For example, updating electronic media, the patient would use the Medication Recording System online system, plug in the Fingerprint Authenticated USB Device and continue to modify the schedule, including adding/deleting medication, dosages, administration of medication, compare the old schedule to the new, verify schedule and review interaction list as similarly explained above with regard to the manual system, FIG. 4.

Similarly, if the patient uses a smart card, then they insert the card in the medication record system computer. The smart card will be recognized as in use. All transactions (updates) retrieved from the card, missing information is noted. Any additional orders are noted. The schedule in medication record system is updated. New transactions are sent to smart card. The printed schedule is verified to match smart card. The smart card returned to patient and sticker with new PDF attached to card.

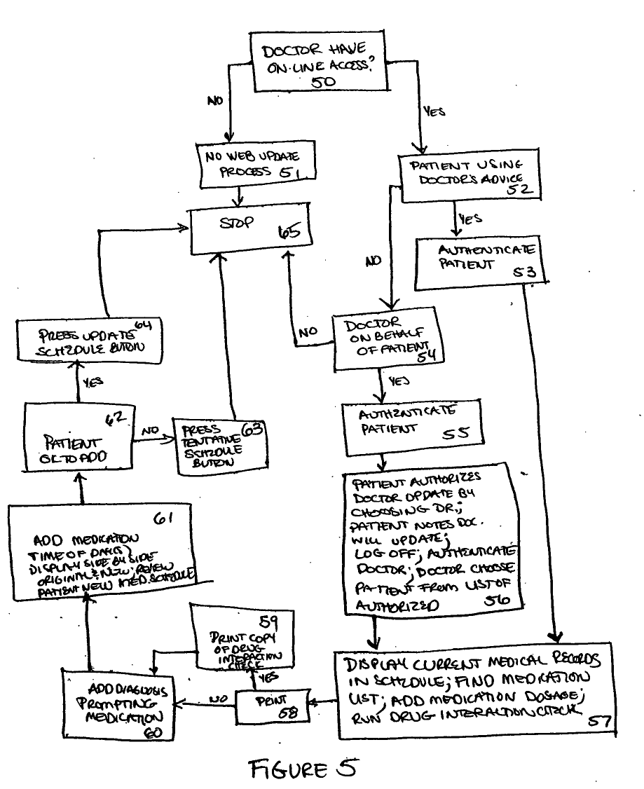

Similarly, there is a web update process available which walks you through the steps and automates the updates. FIG. 5 shows the web based update process.

FIG. 5 is the doctor's online update process. This process flows from make changes (40) of FIG. 4. As shown in FIG. 5, if the doctor does not have online access to the patient medication online schedule, then no web update process is performed (51). If the doctor has access to the online system (50) and the patient uses the doctor's advice (52) then the patient is authenticated (53). Once the patient is authenticated (53), the system allows display of current medical records, schedule, add of medication to list including dosage, and placement in schedule and the drug interaction check is processed (57). However, if the patient does not follow the doctor's advice (52), then the system checks if the doctor is patient's doctor (54), if not the program ends (65). If the doctor is the patient's doctor, then the patient is authenticated (55). The patient authorizes doctor update by choosing doctor, patient notes doctor will update and logs off. The doctor is authenticated, doctor chooses patient from list of authorized patients (56). Then the doctor has access to records, schedule, medication list, can modify accordingly and have a drug interaction check run (57).

Once the modification has been entered by the doctor then doctor may print the interaction list (58) (59). If the doctor chooses not to print or completes the printing then the diagnosis prompting medication change (60) is inputted. The medication time of day is input/verified in administration schedule, the old administration schedule is reviewed/compared to the new administration schedule (61). The patient must “ok” the new addition/change/modification (62). If the patient does not agree with the change then the tentative schedule button (63) is selected, or if the patient does agree with the modification then the update schedule button (64) is selected. The update is complete (65).

Having described the preferred embodiments herein, it should now be appreciated that variations may be made thereto without departing from the contemplated scope of the invention. Accordingly, the preferred embodiments described herein are deemed illustrative rather than limiting, the true scope of the invention being set forth in the claims appended hereto.

What is claimed is:

1. A method of creating an individualized medication recording system, comprising the steps of:
providing an electronic version of a medical records system;
accessing a personal account of said medical records system to provide an individual medical records system;
setting parameters within said system to enable authorized users to view or edit information stored on said individual medical records;
inputting personal medical information where prompted to on said individual medical records system; and
compiling said personal medical information to provide a usable and viewable format.

2. The method of claim 1, wherein said inputting personal medical information which includes name of medication, dosage requirements, number of times a day of administering and time of day to administer said medication or combinations thereof.

3. The method of claim 2, further including the step of printing said daily medication schedule.

4. The method of claim 3 further including the step of following a regimen set for in said daily medication schedule, completing task by taking medication at indicated time of day and dosage as indicated on said schedule and marking said daily medication schedule to indicate completion of task, following regimen until all tasks are completed and said daily medication schedule reflects completion of regimen.

5. The method of claim 4, further including the step of modifying said daily schedule by adding or deleting personal medication information and creating updated daily medication schedule.

6. The method of claim 5, further including the step of checking drug interaction between medications listed on daily medication schedule.

7. The method of claim 6, further including the step of listing all drug interactions for review by patient.

8. The method of claim 7, further including the step of electronically saving said individual medical records system information for future access, updating and review thereof.

9. The method of claim 8, further including the step of accessing said medical records system to authorize other users to view or update said personal medical information.

10. The method of claim 9, further including the step of accessing said medical records system by authorized user for viewing or updating in accordance with predetermined access levels.

11. The method of claim 10, further including the step of accessing said medical records system by said individual for the purpose of printing out a pill sorter filling sheet for updated daily medication schedule.

12. The method of claim 11, further including the step of notifying a primary care provider when said daily medication schedule is updated within the said medical records system.

13. The method of claim 12, further including the step of authorizing a healthcare proxy who will be able to view and update said information within said medical records system when said individual is deemed needing assistance of their predefined healthcare proxy.

14. The method of claim 13, further including the step of storing protected health information on a Fingerprint Authenticated USB Device portable data file cabinet for read access after a fingerprint of said individual has unlocked said information found in said USB Device.

15. The method of claim 14, further including the step of storing medication dispensing information by an authorized pharmacist.

16. The method of claim 15, further including the step of printing a report of medications to be renewed refilled in coming month.

17. A system for providing a medication recording schedule comprising:
an electronic processing system;
a medical records system accessible through said electronic processing system to input medical information specific to a user and store said information thereon;
a daily medication schedule outline stored on said electronic processing system, said outline divides a day into various categories as a function of time, each category includes a section to display medication to be taken, dosage amounts of said medication, time of day of administering medication and a tab to check off upon completion of said medication intake;
a compiling mechanism which links said information stored on said medical records system to said daily medication schedule outline, said compiling mechanism individualizes said schedule by inputting medication names and dosages in to the appropriate category on said outline for a visual display of an individualized daily medication schedule;
a printing mechanism to print said individualized daily medication schedule; and
a notification mechanism to notify primary cares of modifications to said individualized daily medication schedule.

18. The system of claim 18 further including a Fingerprint Authenticated USB Device portable data file cabinet for storing protected health information thereon.

19. A medication recording system schedule comprising a customized hard copy daily schedule of an individuals medication routine for a day, said schedule includes breakdown of a day as a function of time; medication information including at least one medication name, a dosage requirement for said medication, time of day of administering medication; and a recording system to denote medication was administered, said medication information being assigned a specific time of the day for administration.

20. The schedule of claim 19 further including an electronic version of said schedule to be stored on a Fingerprint Authenticated USB Device portable data file cabinet as a read-only file.
